(19) United States
(12) Patent Application Publication
(10) Pub. No.: US 2018/0100938 A1
(43) Pub. Date: Apr. 12, 2018

(54) Continuous Subsurface Carbon Dioxide Injection Surveillance Method

(71) Applicant: Seismos Inc., Austin, TX (US)

(72) Inventors: Panagiotis Adamopoulos, Lakeway, TX (US); Jim Cannon, Spring, TX (US); Jakub Felkl, Austin, TX (US)

(21) Appl. No.: 15/832,996

(22) Filed: Dec. 6, 2017

Related U.S. Application Data
(63) Continuation of application No. PCT/US2016/065995, filed on Dec. 9, 2016.
(60) Provisional application No. 62/266,025, filed on Dec. 11, 2015.

(51) Int. Cl. G01V 1/30; G01V 1/28; G01V 1/42; E21B 47/10; E21B 43/16

(52) U.S. Cl. CPC G01V 1/306; G01V 1/288; G01V 1/42; G01V 2210/1234; E21B 47/101; E21B 43/164; G01V 1/305

(57) ABSTRACT

A method for characterizing a subsurface fluid reservoir includes inducing a pressure wave in a first well traversing the subsurface reservoir. A pressure wave in at least a second well traversing the subsurface reservoir is detected. The detected pressure wave results from conversion of a tube wave generated by the pressure wave in the first well into guided waves. The pressure wave in the at least a second well is generated by conversion of the guided waves arriving at the at least a second well. A guided (K) wave travel time from the first well to the at least a second well is determined and a physical property of the subsurface fluid reservoir is determined from the K-wave travel time.

### CROSS REFERENCE TO RELATED APPLICATIONS

Continuation of International (PCT) Application No. PCT/US2016/065995 filed on Dec. 9, 2016. Priority is claimed from U.S. Provisional Application No. 62/266,025 filed on Dec. 11, 2015.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of seismic subsurface analysis, and is related to hydrocarbon extraction, mining or other characterization of fluids in subsurface earthen formations, such as carbon dioxide injected into a subsurface formation for enhanced recovery or permanent storage.

In the productive lifetime of some conventionally produced hydrocarbons, e.g., oil from a subsurface reservoir, so-called “primary” production may driven by natural fluid pressure in the reservoir (i.e., gravity & reservoir pressure). Extraction of fluids from the reservoir may result in a drop in such natural pressure in some reservoirs. At the time at which the fluid pressure in the reservoir drops below the pressure needed to maintain commercially useful fluid production rates, so-called “secondary” production methods may be implemented to extract additional hydrocarbons from the reservoir. One type of secondary production technique is water injection. Water injection is implemented to increase the reservoir pressure, driving additional production. Water injection may be implemented by pumping water into one or more wells that are hydraulically connected to the reservoir. As additional hydrocarbons are withdrawn from the reservoir, eventually the response of the reservoir to water injection slows as the remaining hydrocarbons in the reservoir become less mobile. Loss of hydrocarbon mobility is related to replacement of hydrocarbons in the reservoir pore spaces by the injected water. A field operator may then decide on additional, tertiary, or “enhanced” oil recovery (EOR) techniques. EOR techniques may have as a desired characteristic increasing the mobility of the remaining hydrocarbons in the reservoir. Such EOR techniques include injection of surfactants or other chemicals that reduce remaining oil viscosity, and help push/displace it through the reservoir to a producing well. Carbon dioxide (CO₂) gas has been used with much success at increasing oil recovery from certain oilfields where the response to injection of the gas resulted in significantly increased hydrocarbon recovery. In other cases, injected fluid is not only compressed CO₂ but can include nitrogen (N₂), natural gas—methane (CH₄), or other compressed gases or liquids and their combinations based on availability and favorable miscibility or chemistry.

In an ideal and homogeneous reservoir case, the CO₂ (injected fluid) would expand in concentric fashion from an injection well. Homogeneity of subsurface reservoirs is rarely the case, and CO₂ injection field experience shows that often CO₂ finds preferential pathways that do not optimize hydrocarbon recovery. Because CO₂ injection is an expense for an operator, there is an incentive to maximize contact of CO₂ with oil remaining in the reservoir, while minimizing CO₂ subsurface “leaks” outside of the CO₂ movement pattern, and even more so the need to optimize CO₂ utilization to maximize production.

However, at present operators have no clear, timely, and practical visibility to the CO₂ (or other injected fluids) propagation, flow, and dispersion underground. Current techniques of limited practicability that have been used include vertical seismic profiles (VSPs), 4D (time lapse 3D surveys) surface reflection seismic surveys, or cross-well propagations studies. The foregoing techniques may be expensive, disruptive to field operations (explosives, trucks, production shutdowns, . . . ), and some take a very long time to process. Therefore, most well or field operators do not view such methods as cost-effective and rarely use them. This often results in premature breakthroughs, trapping uncollected oil underground surrounded by injected fluid, or significant losses into far away or undeveloped parts of the formation due to natural subsurface pathways (such as unknown fractures not discernable with conventional seismic surveys) within the reservoir. The aim of this invention is to overcome such drawbacks with minimal well instrumentation and minimal operations disruptions.

Furthermore, this disclosure extends beyond the typical application of CO2 or other fluid-enhanced oil recovery into additional subsurface reservoir or layer characterization.

This disclosure also relates to processing cross-well seismic signals to obtain a time-lapse and repeated measurements for understanding of subsurface fluids positions or concentrations between wells, in a larger oilfield area or within a geological formation at various times.

U.S. Pat. No. 7,529,151 and U.S. Pat. No. 7,602,669 “Tube-wave Seismic Imaging” issued to Korneev, herein incorporated by reference, disclose newly detected seismic waves effects and use of tube waves generated in a well, passing into a formation in a guided mode (K-wave) and re-converting into tube waves at another well, with arrival after initial compressional wave through a geological field. The disclosure of the foregoing two patents also emphasizes the necessity for fluid connectivity through apertures (perforations) made in well casings for passage of fluid between the well and the reservoir formation but such connection may not always be necessary.

Understanding subsurface fluids in a geological formation is of importance for both hydrocarbon or mineral extraction, but also in more recent efforts to store (sequester) and contain certain gases (such as CO₂) underground for long term storage and access. Leaks in storage formations may be detected by setting up a “perimeter” around it, where cross-well time delays would indicate infiltration of space between wells with a foreign substance.

### SUMMARY

A method according to one aspect of the disclosure includes characterizing a subsurface fluid reservoir by inducing a pressure wave in a first well traversing the subsurface reservoir. A pressure wave in at least a second well traversing the subsurface reservoir is detected. The detected pressure wave results from conversion of a tube wave generated by the pressure wave in the first well into guided (K) waves. The pressure wave in the at least a second well is generated by conversion of the guided (K) waves arriving at the at least a second well. A guided (K) wave travel time from the first well to the at least a second well is determined and a physical property of the subsurface fluid reservoir is determined from the K-wave travel time.

In one embodiment, the physical property includes comprises a position of a fluid front of a fluid injected into one of the first well and the at least a second well between the first well and the at least a second well.

### BRIEF DESCRIPTION OF THE DRAWINGS

FIG. 1 shows schematically a single well and source and sensor placement.

FIG. 2 shows an arrangement of a seismic source and a seismic receiver for three wells that penetrate a subsurface reservoir formation in a cross-section to illustrate the principle of methods according to the disclosure.

FIG. 3A shows an example pattern of installation (5 wells) with an injector in the middle

FIG. 3B shows example measurement patterns between pairs of wells.

FIG. 3C shows further example measurement patterns superimposed over potential subsurface reservoir fluid distribution.

FIG. 4A shows a model of a reservoir formation, seismic source and seismic receiver for two wells drilled through the reservoir for modelling seismic wave propagation between wells and into the wells.

FIGS. 4B through 4D show simulated seismic waves and arrival times of guided-waves with respect to propagation of a CO₂ flood in the reservoir.

FIG. 4E shows superimposed detected seismic signals from a plurality of different measurement times at one well (of a well pair) to illustrate a relationship between guided (K) wave propagation time and propagation distance of a CO₂ flood front.

FIG. 5 shows measurement patterns for a field having a plurality of producing wells and injection wells with estimated progression of injected fluid with respect to time mapped on each of the injection wells.

FIG. 6 shows an example computing system in accordance with some embodiments.

### DETAILED DESCRIPTION

This disclosure explains methods that extend the use of tube wave seismic imaging into a larger area such as that of a subsurface hydrocarbon (e.g., oil) reservoir. Of particular interest are late wave arrivals, guided, “trapped” waves propagating through an oil bearing reservoir formation or other mineral deposit-rich subsurface formation.

Furthermore, methods according to the present disclosure can extend beyond the application to monitoring CO₂ or other fluid-enhanced oil recovery, into a subsurface reservoir or layer characterization by detecting changes in arrival signals once fluid has been injected to monitor a perimeter surrounding the storage region.

The present disclosure also describes methods for processing seismic signals such as tube waves to obtain time-lapse and repeated measurements for understanding of subsurface fluid spatial distribution between wells in a hydrocarbon reservoir area or within a selected geological formation.

The description herein uses specific examples but such examples are not necessarily the only intended or possible implementation or use of the disclosed methods. A person having skill in the art can develop other implementations having the same goals as the disclosed examples. Methods according to this disclosure make practical use of pressure waves, guided, surface, and seismic waves, including their resonances, to determine inter-well fluid parameters within a subsurface formation or reservoir. Also note that methods according to the present disclosure are applicable to vertical, horizontal, or any other deviated set(s) of wells that undergo a treatment or fluid flow conditions in the subsurface.

Methods according to the present disclosure may provide benefits to a producing reservoir operator in that the measurements may be performed from the surface, with minimal disruption to field operations. Such benefits may include, e.g., and without limitation, no wireline well intervention, no tools or instrumentation placed in a well or wells, no large seismic sensor arrays, no use of explosives, seismic hammers or seismic vibrator trucks, and no shutdown of production and injection operations required.

Methods according to the present disclosure may use various forms of active seismic energy sources that generate pressure pulses in a “source well.” Such active sources may be, for example and without limitation, water hammer, fluid treatment pumps, air-guns, and the like as described herein. For example quickly removing (or adding) a volume of fluid to a well will generate a negative (or positive) pressure pulse that propagates downhole. Similarly, a rapid interruption of a fluid flow, or a rapid injection or motion of a volume of a fluid in the well/reservoir system can generate a measurable pressure pulse in a well and corresponding tube waves. A slow fluid flow rate change, with accompanying pressure change, such as that of varying flow, may also induce seismic signals through the well into the formation.

A broadband or specific frequency acoustic excitation event in a wellbore may generate a tube wave in the well. Typically, tube waves are a nuisance in seismic data acquisition and processing but they can be used for evaluating petrophysical properties pertaining to guided or fracture wave propagation modes. In methods according to the present disclosure, properties of tube waves may be used to determine propagation distance of a selected fluid within a subsurface reservoir formation as such fluid injected into the reservoir formation. In an embodiment according to the present disclosure, sensors may be placed on the surface near, at, or contacting the fluid inside a well. The sensors may include but are not limited to hydrophones that are connected to the wellbore fluid, other acoustic measurement sensors (to measure ambient noises), accelerometers, pressure transducers, jerk-meters (measure derivative of acceleration), geophones, microphones, or similar sensors. Other physical quantities can also be measured, such as temperature to provide temperature corrections and calibrations or for data consistency checks for all the sensors. Measuring nearby ambient surface noise using microphones, geophones, accelerometers or similar sensors can help in reducing noise signal(s) in fluid pressure or pressure time derivative sensor data (e.g., pump noise as contrasted with fluid resonances, surface machinery, multiple tube wave bounces, . . . ) Sensors for measuring chemical composition and density of the pumped fluid may be used to improve analysis and may therefore be implemented in some embodiments. Note that to verify that two wells are (and how well) hydraulically connected within the reservoir, one can measure their respective pressure responses.

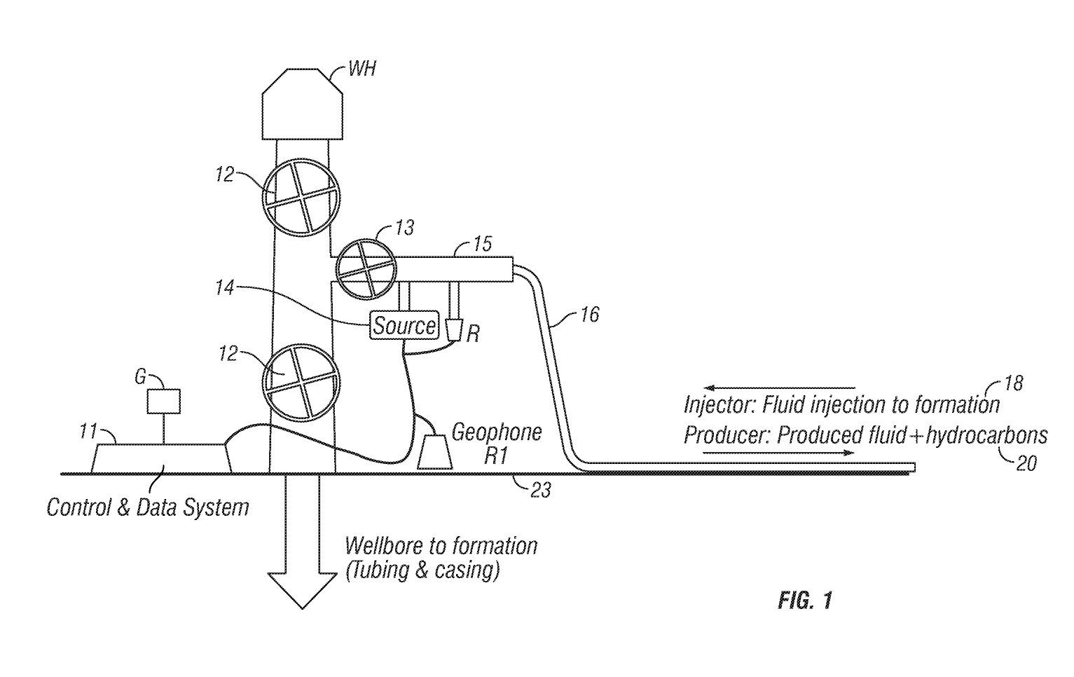

Continuous/passive/background seismic energy sources may be embedded in various operations taking place in the vicinity of the reservoir formation or may occur naturally even at a significant distance. Such passive or continuous seismic energy source may include general pumping noise, pump noise related to pump piston motion, valve actuations, microseismic events (fracturing that may occur naturally or as a result of pumping fluids), other geological phenomena not generally related to the oilfield operation (e.g., natural seismicity, near and far-field earthquakes). If the seismic energy source is on the surface, it can be discerned based on time of arrival of seismic energy detected by the surface- or well-based sensors, e.g., R, R1 in FIG. 1.

The use of a passive/natural (e.g. subsurface micro earthquake) sources in continuous monitoring and analysis cases may comprise the following: assuming a source of seismic activity within or outside of the reservoir, the seismic energy will travel and consecutively generate pressure pulses in each well as the energy reaches each well in the subsurface. The subsurface pressure pulses will propagate upward through second wellbore and may be detected by a surface receiver, e.g., R in FIG. 1. From the known tube wave travel times for each well, known travel distance within the reservoir, the natural-source guided wave speed between wells can be determined. If the guided wave speed in the subsurface is known, for example, from prior measurements or calculations, a direction or location of the source can be discerned (triangulated). To confirm the signal origin, the approximate shape, profile, or frequency content of the detected signals can be compared across a plurality of or all the seismic receivers (R in FIG. 1).

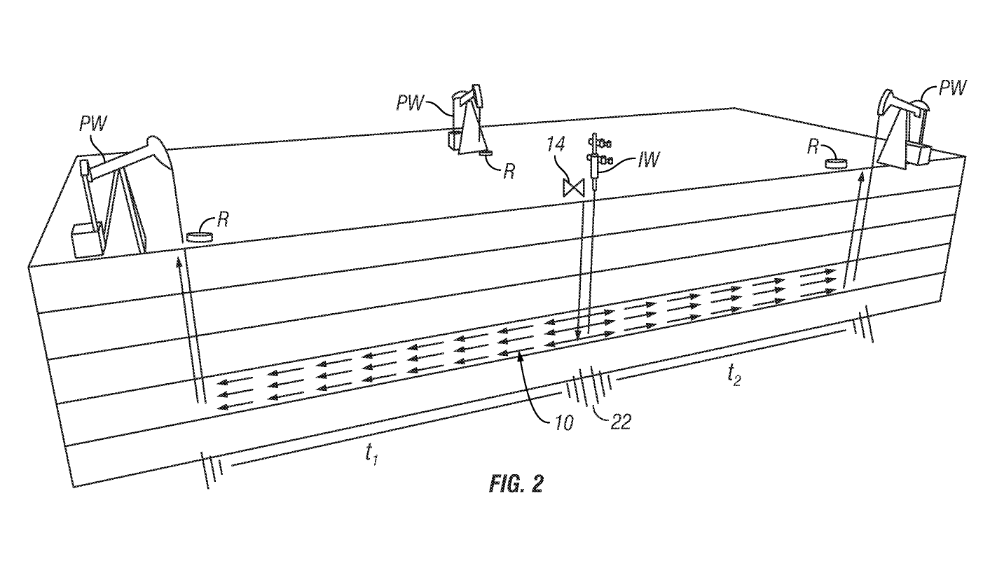

A well may be instrumented as is schematically depicted in FIG. 1. A well, whether it is a fluid producing well (PW in FIG. 2) or a fluid injection well (IW in FIG. 2) may have at the surface a wellhead WH having one or more valves V (12, 13) that control fluid flow into and out of the well. The wellhead WH may comprise a flow line 15 fluidly connected to the wellhead WH, and may include a wing valve 13 to close the flow line 15 to fluid flow when required. A fluid line 16 connects the flow line 15 to either a fluid source 18 such as from a pressurized container/injection system (not shown) or a fluid receptacle 20 such as a surface treatment system of types known in the art. The fluid line 16 connection to the fluid source 18 or receptacle 20 will depend on whether the well is a producing well or an injection well. A seismic energy source 14, which may be any of the types described above may be in fluid communication with the well, for example by placement in fluid communication with the flow line 15. A seismic sensor or receiver R, for example, a hydrophone, may be placed in fluid communication with the fluid in the well in a similar manner, e.g., by connection to the flow line 15. A ground surface seismic sensor R1 such as an accelerometer, geophone, velocity meter, tiltmeter, jerk meter or any similar sensor may be placed in contact with the ground surface 23 for detecting certain types of acoustic signals as will be further explained below. Each well can be instrumented as described above, although specific well and field geometry will be guided by the field- and well-specific conditions. Such specific conditions may include a series of check valves in a rod-pump producer scenario. In general, closed valves or partial flow barriers should be avoided in the pathway between source/sensor and downhole reservoir formation.

The seismic energy source 14, seismic sensor R and the ground surface seismic sensor R1 may be in signal communication with a control and recording device 11. The control and recording device 11 may comprise (none of the following shown separately) a seismic energy source controller, a seismic signal detector, a signal digitizer, power supply/source, and a recording device to record the digitized detected seismic signals from the seismic receiver R and the ground surface seismic sensor R1. The source controller (not shown) may be configured to actuate the seismic energy source 14 at selected times and cause the sensors R, R1 to detect seismic signals at selected times, or substantially continuously. The control and recording device 11 may comprise an absolute time reference signal detector G, for example, a global positioning system (GPS) satellite signal receiver or a global navigation satellite system (GNSS) signal receiver. The absolute time reference signal detector G may be used to synchronize operation of the control and recording device 11 with similar control and recording devices on other wells that penetrate a selected subsurface formation or reservoir. All of these devices may be operated remotely. Injector, producer or fluid-filled observation wells may be similarly instrumented.

As shown in FIG. 2, a well, for example an injection well IW into which a fluid is to be injected into a subsurface reservoir 10, may have a seismic source 14 in fluid communication with fluid in the well, e.g., injection well IW. A seismic receiver or sensor R may be disposed in or near at least one other well, and in some embodiments a plurality of wells. Examples of such wells may comprise fluid producing wells PW that are in fluid communication with the subsurface reservoir 10. Acoustic waves introduced into one well from the seismic energy source 14 may be converted to guided-waves (K-waves) 22 in the reservoir formation 10. The guided waves 22 propagate through the subsurface reservoir 10 until a well is reached that has a seismic sensor or receiver R disposed therein or proximate thereto. On arriving at a well having a seismic sensor R, the guided (K) waves 22 are converted into tube waves in a wellbore and may then be detected at the seismic sensor R. Example travel times of the (K) waves 22 through the reservoir formation 10 may be represented by t₁ and t₂ in FIG. 2. Guided (K) wave travel and propagation times may be related to certain physical parameters of the reservoir formation 10, such as distance from the injection well IW to which an injected fluid has moved from the injection well IW (or the fluid composition between IW and PW).

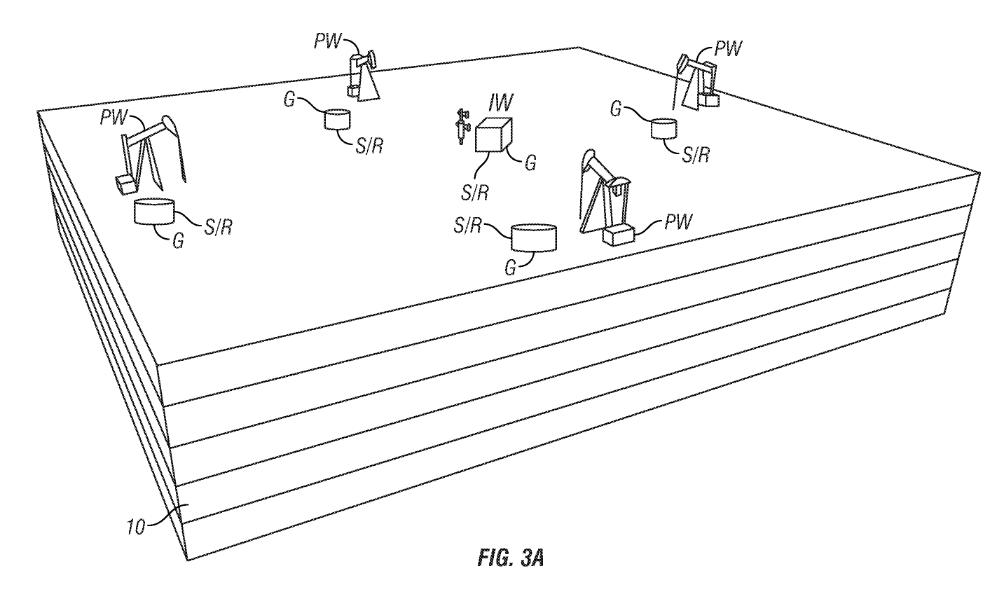

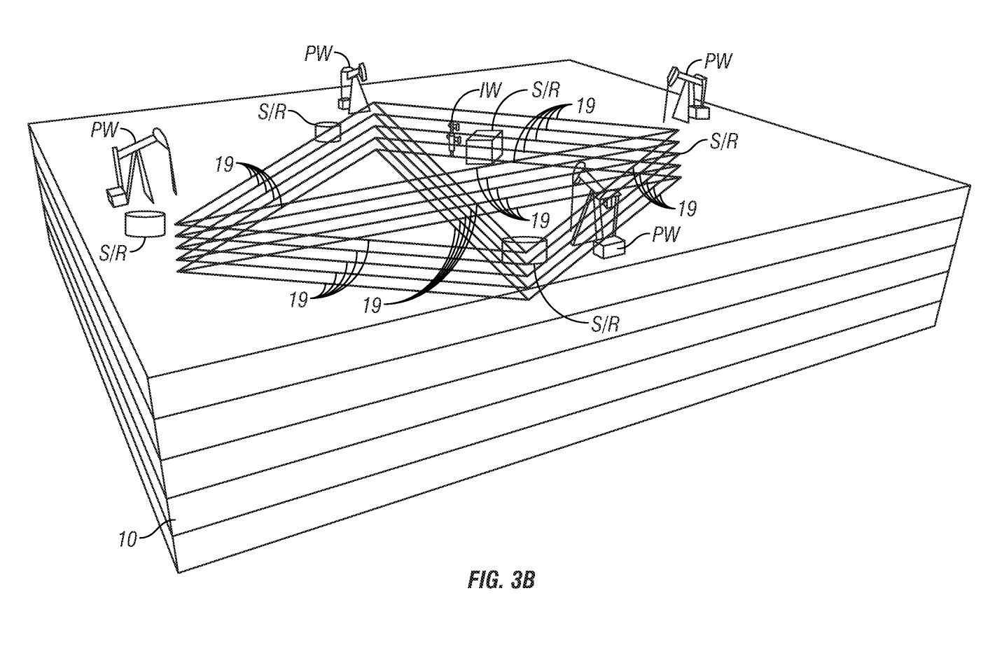

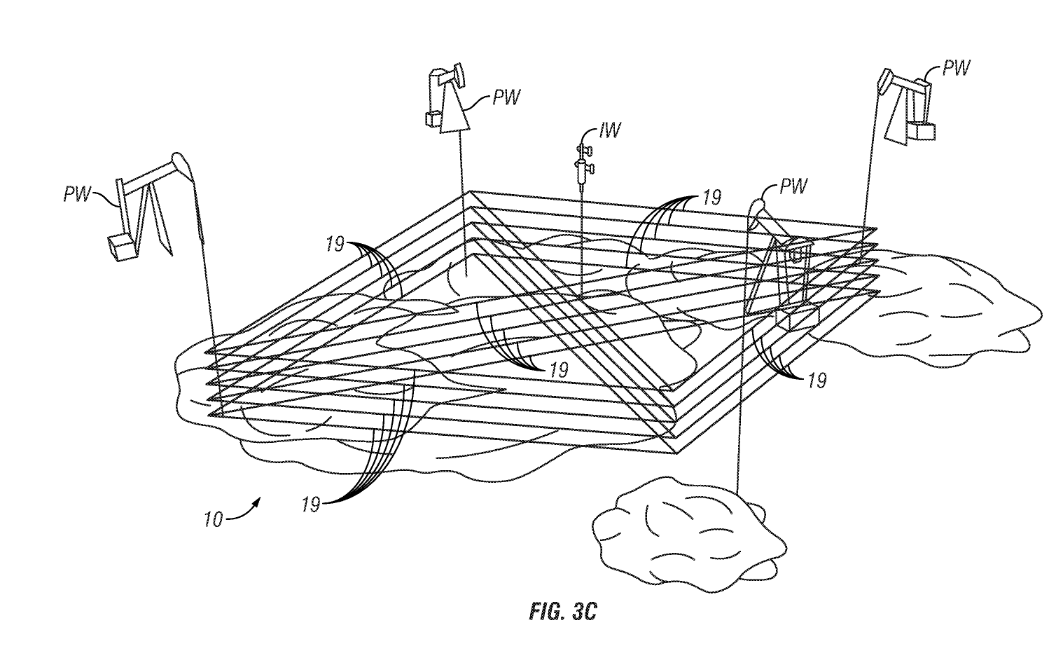

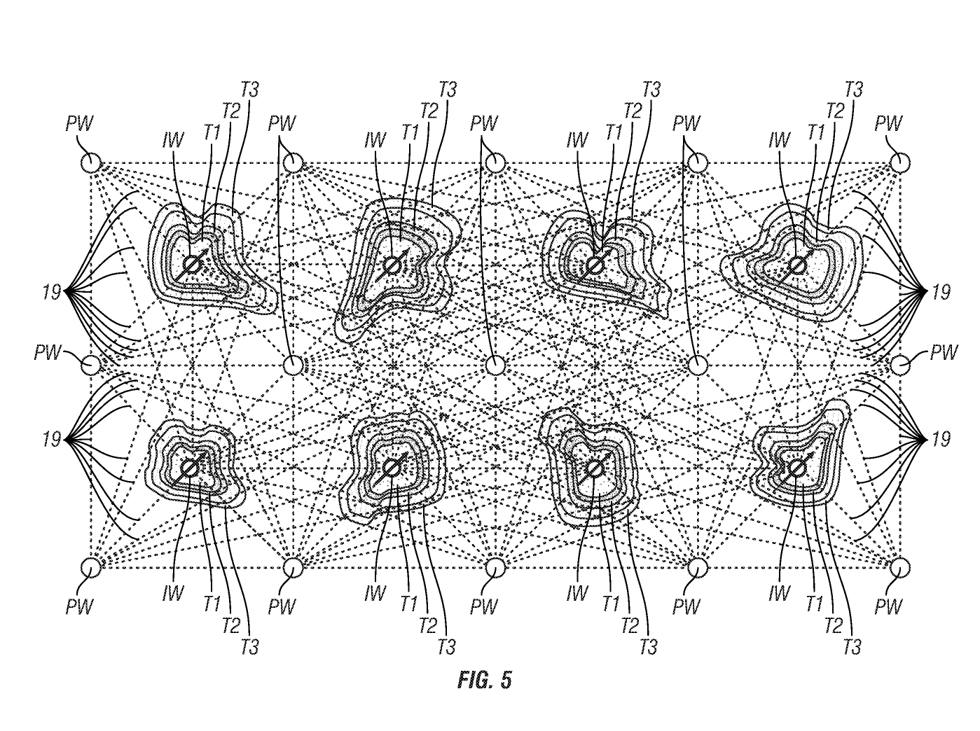

An example measurement pattern for a selected subsurface reservoir can be implemented as shown in FIG. 3A. The example pattern in FIG. 3A comprises four producing wells PW near an injection well IW. All the wells PW, IW may be instrumented as shown in FIG. 1. Each well IW, PW in the present example embodiment comprises both a seismic source and seismic sensor (shown at source and receiver S/R in FIG. 3A) for example, such as shown in FIG. 1, measurements may be made coupled thereto for generation and detection of guided (K) wave propagation time seismic signals between any one or more pairs, or each possible pair of wells in the pattern of wells IW, PW or PW, PW. By having each well IW, PW comprise a seismic source and seismic sensor (shown at S/R in FIG. 3A) for example, such as shown in FIG. 1, measurements may be made of K-wave propagation time between any pair of wells in the pattern. Such possible pairs of wells for the well arrangement of FIG. 3A are shown schematically in FIG. 3B by travel paths 19 traversed by the guided K-waves during any measurement made between any pair of wells. FIG. 5 illustrates that similar measurement patterns may include further wells beyond the single well pattern shown in FIG. 3A. FIG. 3C schematically displays a possible distributions of fluids in the subsurface. In addition, having two wells, e.g. PW and IW instrumented with source and a receiver, IW→PW and reciprocal, return PW→IW signals and travel times may be compared, analyzed, or averaged to obtain a more accurate interpretation.

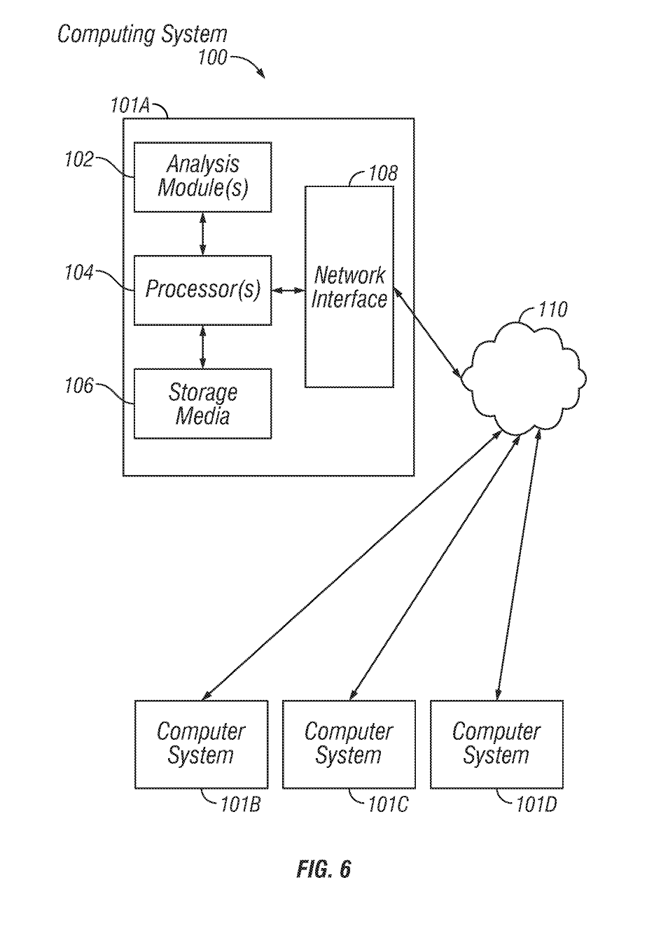

More than one sensor (e.g., the sensor R in FIG. 1) for each well is not required, however additional sensors placed proximate the wellhead (WH in FIG. 1) such as a ground surface sensor (R1 in FIG. 1) may provide higher accuracy, such as directionality of propagating signals, ambient noise records for noise abatement, ground vibration measurements, steel casing vibrations, etc. Thus methods according to the present disclosure may benefit from using such additional sensors. In some embodiments all the sensors should have substantial response at about 1 kHz or above as well as sonic and sub-sonic (<20 Hz). The signals from the sensors may be amplified, filtered, captured, digitized, recorded and stored in the control and recording unit (11 in FIG. 1A) associated with each well, and subsequently transferred to a computer, computer system or similar device for processing. One example of such a computer or computer system will be explained further with reference to FIG. 6.

Measurements from the various sensors may be time synchronized. One embodiment of synchronizing sensor measurements may comprise using GPS or GNSS absolute time signals at the sensors or on the recording system. In such embodiments, as shown in FIG. 3A at G, a GPS or GNSS satellite signal receiver may be disposed proximate each well IW/PW.

A first measurement can occur before injection of any fluid begins or at any point during or after fluid injection has begun. The first measurement may be called a “baseline”, from which any subsequent measurements can be referenced. The baseline time arrivals between a defined well pair, can then be compared to a measurement of the same time signal trace at any future time. All else equal, normalized, and corrected (for pressure and temperature changes) travel time of a guided (K) wave identifies the characteristic of the saturating fluid in the reservoir and pressures. Increase in time arrival indicates increase of concentration of slower propagating fluid such as CO₂; decrease in arrival time indicates reduction of slower propagation fluid (e.g. CO₂) and to maintain approximate mass-balance—thus a decrease of (inter-well concentration of) faster fluid (such as CO₂), indicating a subsurface fluid motion, migration, or progression.

For the example well pattern shown in FIG. 3A, an example illustration of spatial distribution of injected fluid (e.g., CO₂) is shown schematically in FIG. 3C. The injected fluid is shown by approximate shapes 21. The shapes 21 are only provided as examples of how an injected fluid may be spatially distributed in a subsurface reservoir (e.g., as shown at 21 in FIG. 3C) and is not in any way intended to limit the possible fluid distributions that may be determined using methods according to the present disclosure.

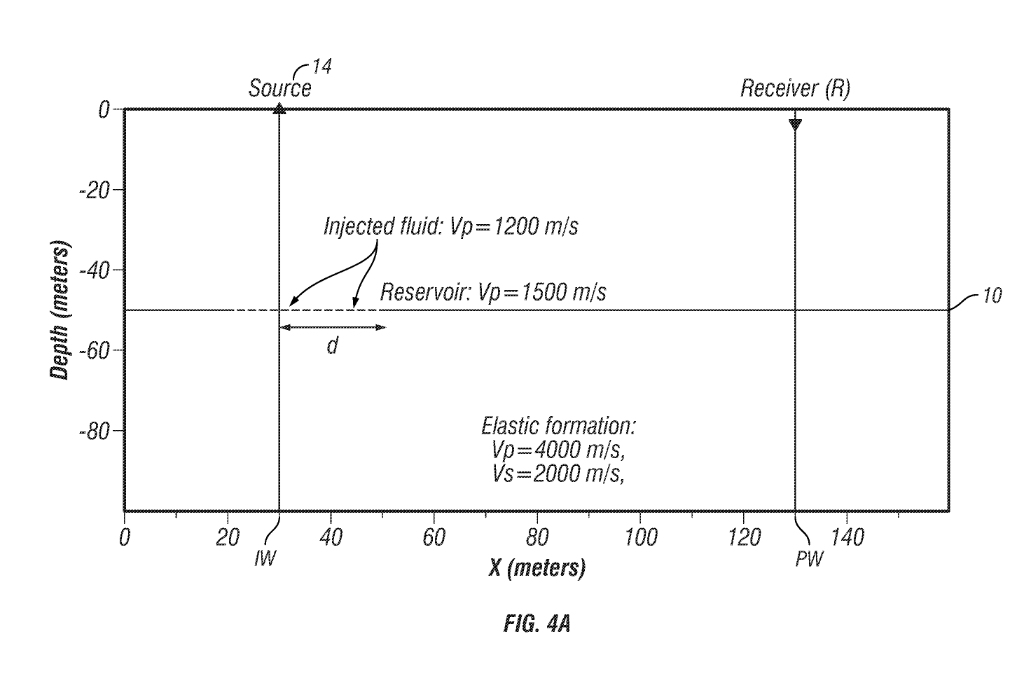

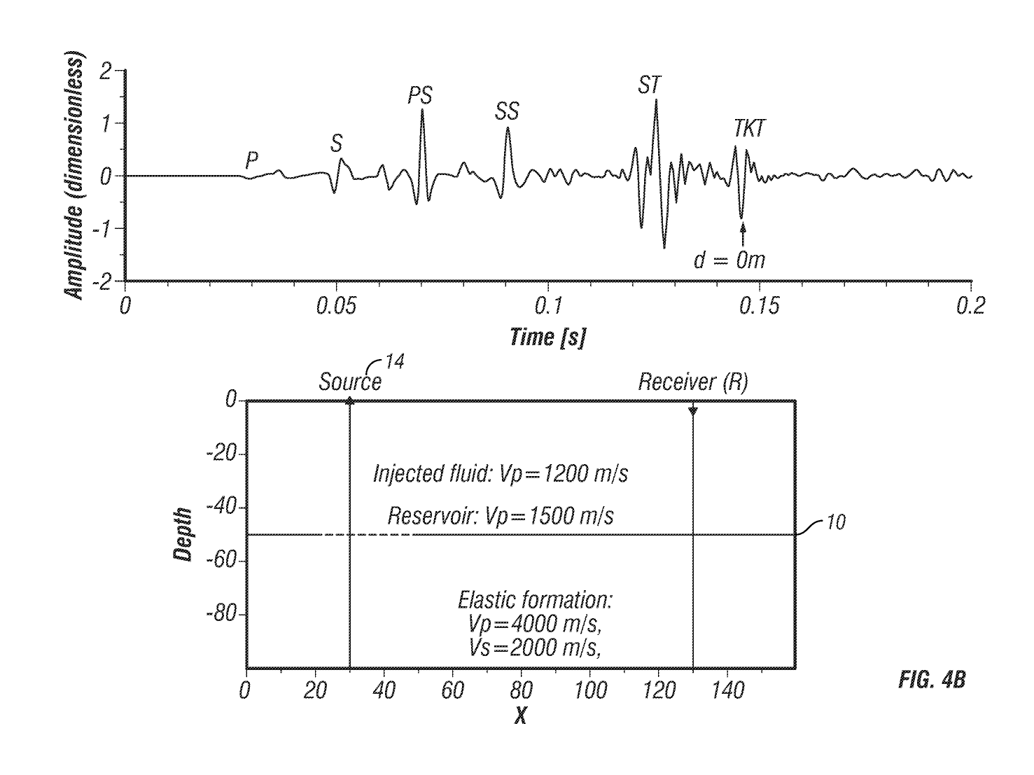

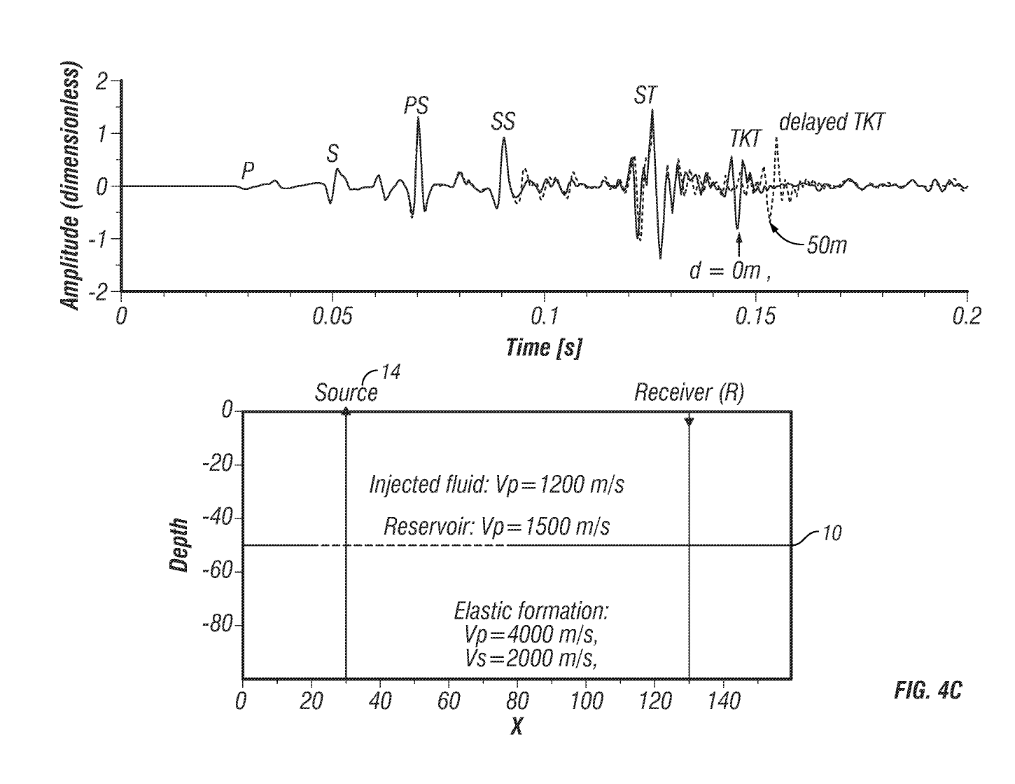

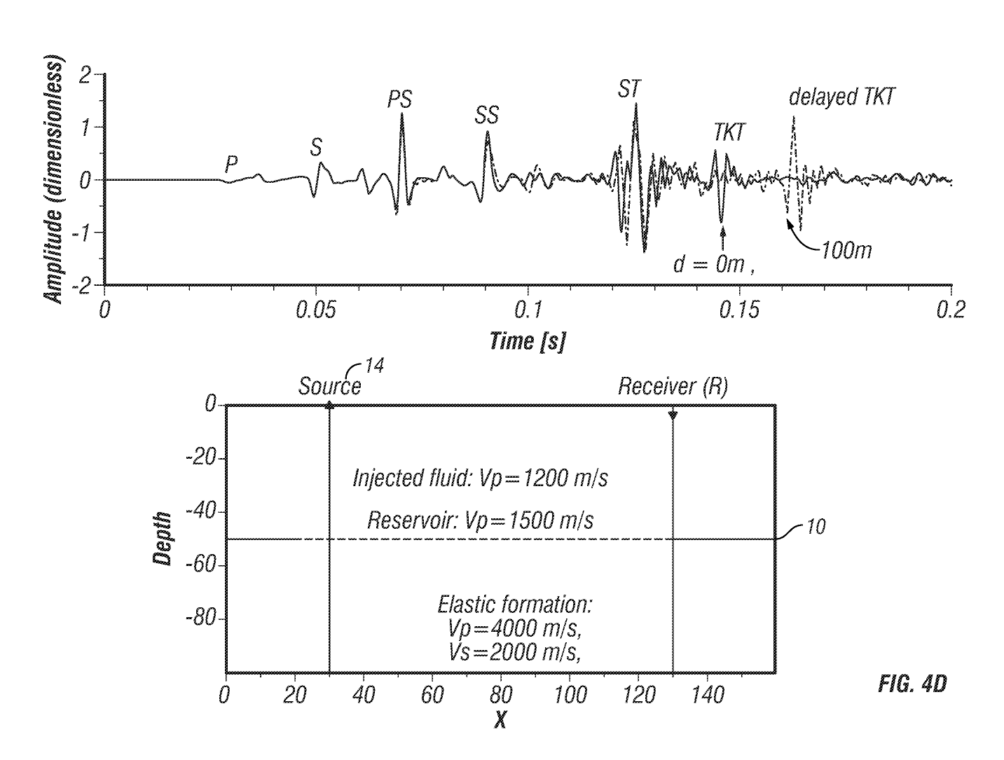

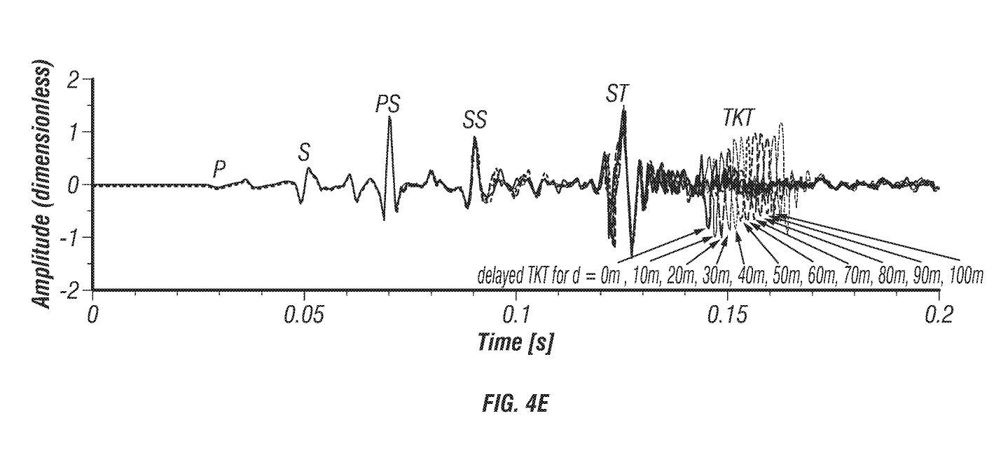

FIG. 4A shows a cross-section of an example arrangement of an injection well IW and a producing well PW drilled through a subsurface reservoir 10. Injected fluid may have a compressional (P) wave velocity of, for example, 1200 meters/second. Fluid already present in the subsurface reservoir 10 may have a P wave velocity of 1500 meters/second. The reservoir formation 10 may have a P wave velocity of 4000 meters/second and a shear (S) wave velocity 2000 meters/second.

As shown in FIGS. 4B, 4C, and 4D, arrival times of compressional waves P, shear waves S, compressional/shear converted waves PS, shear/shear converted weaves SS and Stoneley waves ST are substantially independent of the position of the CO₂ front between a source well and a measurement well. The speed of tube/K-waves (TKT) in the subsurface reservoir 10 varies based on the medium in the pore spaces of the subsurface reservoir 10 (e.g., CO₂, water, oil). In particular, the contrast in TKT speed between water and CO₂ is significant and allows for a measurable time difference between measurements with respect to CO₂ propagation distance. FIG. 4E shows superimposed, simulated detected signal waveforms for a plurality of CO₂ movement or propagation distances (d=10,20 . . . 100 m) from the injection well (IW in FIG. 3A).

FIG. 5 shows an example arrangement of injection wells IW and producing wells PW. Measurements of TKT wave propagation time between each injection well IW and a plurality of surrounding producing wells PW (as well as in-between PWs) may be made at selected time intervals. Such time intervals are shown at T1, T2 and T3 in FIG. 5. The arrival time of the TKT wave at each of the surrounding producing wells PW will be related to a propagation or movement distance of the CO₂ flood front along multiple directions at each time interval T1, T2, T3, and thus may be interpolated into a time-based flood front map for each injection well IW. Such a map may assist the operator in determining, for example, sweep efficiency of the CO₂ flood by noting the degree of non-circularity of the flood front with respect to time. The map can also help operator adjust injection pattern to optimize oil contact and production.

Data processing may include repeating actuating each seismic energy source (14 in FIG. 1), waiting a selected time for the tube waves converted to guided (K) waves to propagate from the source well to the receiver R at each of the other instrumented wells, and repeating the foregoing a plurality of times to enable “stacking” the detected signals from each receiver R and thereby improve signal to noise ratio. Another possible way to reduce noise is to provide a well-defined and precisely timed signal at each seismic energy source while identifying a similar signature from the signals detected by each receiver R. Time-frequency analysis may be used to show change of the detected TKT wave spectrum over time. Frequency domain analysis, such as may be provided by a Fourier transform can then have a better resolution in the time-frequency stationary period. Additional methods applicable may include cross-correlation, autocorrelation, deconvolution, compressive sensing, ray-tracing, frequency lock-in, and others as may be useful to improve signal-to-noise ratio.

In some embodiments, at least one additional reservoir characteristic may be determined based on at least one of cross-well frequency change and cross-well amplitude change between wells.

These measurements may be repeated regularly, e.g., on the order of once every few weeks to monitor the subsurface fluid front progression.

In some embodiments, measurements from a plurality of sensors such as shown in

FIG. 1 comprising pressure transducers, accelerometers, or geophones may be used to reduce surface-based noise, reconfirm the existence of strong events, and/or to eliminate certain frequencies in the signals such as those originating from the pumps or surface activity instead of the reservoir and/or fractures or subsurface signals carried though the wellbore.

After noise reduction and improving signal to noise ratio of the pressure and/or pressure time derivative measurements, frequency domain techniques may be applied to a single set of measurements or a plurality of sets of measurements. The frequency spectrum of the pressure or pressure time derivative sensor (e.g., hydrophone) measurements may change with changers in subsurface reservoir properties over time. Injection/production flow rate and other physical variables may also vary the result. Peak amplitude picking and general structure of the spectrum of the measured signals may be used to further analyze and interpret the data.

Even though flood front imaging and progression has been disclosed, aspects of methods according to this disclosure can be further extended to other uses. For example, tube waves/Stoneley waves traveling through the wellbore reflect from well (casing) diameter and casing weight changes, as well as surface imperfections in the wellbore, such as perforations. Any blockage will also be visible as the dominant reflection time(s) will change. Potential blockages or irregularities in the wellbore can be identified from the tube wave reflections in the wellbore as tube waves are sensitive and partially reflect of off diameter changes or casing changes in the wellbore. Additionally, polarity of the wave reflection determines the fixed (blocked) or open, quasi-static end of a wellbore. Setting up a perimeter in a fluid reservoir, one can look for a contrast (guided (K) wave speed contrast) fluid entering or crossing such a perimeter, for example if a sequestered CO₂ or another foreign fluid crosses a geological boundary.

FIG. 6 shows an example computing system 100 in accordance with some embodiments. The computing system 100 may be an individual computer system 101A or an arrangement of distributed computer systems. The individual computer system 101A may include one or more analysis modules 102 that may be configured to perform various tasks according to some embodiments, such as the tasks explained with reference to FIGS. 2 through 5. To perform these various tasks, the analysis module 102 may operate independently or in coordination with one or more processors 104, which may be connected to one or more storage media 106. A display device such as a graphic user interface of any known type may be in signal communication with the processor 104 to enable user entry of commands and/or data and to display results of execution of a set of instructions according to the present disclosure.

The processor(s) 104 may also be connected to a network interface 108 to allow the individual computer system 101A to communicate over a data network 110 (wired or wireless) with one or more additional individual computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well location, while in communication with one or more computer systems such as 101C and/or 101D that may be located in one or more data centers on shore, aboard ships, and/or located in varying countries on different continents). A processor may include, without limitation, a microprocessor, microcontroller, processor module or subsystem, programmable integrated circuit, programmable gate array, or another control or computing device

The storage media 106 may be implemented as one or more computer-readable or machine-readable storage media. Note that while in the example embodiment of FIG. 6 the storage media 106 are shown as being disposed within the individual computer system 101A, in some embodiments, the storage media 106 may be distributed within and/or across multiple internal and/or external enclosures of the individual computing system 101A and/or additional computing systems, e.g., 101B, 101C, 101D. Storage media 106 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that any other embodiment of a computing system may have more or fewer components than shown, may combine additional components not shown in the example embodiment of FIG. 6, and/or the computing system 100 may have a different configuration or arrangement of the components and controls shown in FIG. 6. The various components shown in FIG. 6 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, PLCs, or other appropriate devices. These modules, combinations of these modules, and/or their combination with general hardware are all included within the scope of the present disclosure.

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f), for any limitations of any of the claims herein, except for those in which the claim expressly uses the words “means for” together with an associated function.

What is claimed is:

1. A method for characterizing a subsurface fluid reservoir, comprising:
inducing a pressure wave in a first well traversing the subsurface reservoir;
detecting a pressure wave in at least a second well traversing the subsurface reservoir, the detected pressure wave resulting from conversion of a tube wave generated by the pressure wave in the first well into guided (K)waves, the pressure wave in the at least a second well generated by conversion of the guided (K)waves arriving at the at least a second well;
in a computer, determining a guided (K) wave travel time from the first well to the at least a second well; and
in the computer, determining a physical property of the subsurface fluid reservoir from the guided (K) wave travel time.

2. The method of claim 1 wherein the inducing a pressure wave comprises actuating a seismic energy source in fluid communication with fluid in the first well.

3. The method of claim 1 wherein the detecting a pressure wave comprises detecting a signal from a hydrophone in fluid communication with fluid in the at least a second well.

4. The method of claim 1 wherein the first well comprises a fluid injection well.

5. The method of claim 1 wherein the at least a second well comprises a fluid producing well.

6. The method of claim 1 wherein the physical property comprises a position of a fluid front of a fluid injected into one of the first well and the at least a second well between the first well and the at least a second well.

7. The method of claim 1 wherein at least one additional reservoir characteristic is determined based on at least one of cross-well frequency change and cross-well amplitude change of the pressure wave.

8. The method of claim 6 wherein the injected fluid comprises carbon dioxide.

9. The method of claim 7 wherein a native fluid in the subsurface fluid reservoir comprises oil, water and mixtures thereof.

10. The method of claim 1 further comprising, inducing a pressure wave in a plurality of first wells, detecting a pressure wave in a plurality of second wells in a selected pattern surrounding each of the plurality of the first wells, in the computer determining the guided (K) wave travel time between each of the plurality of first wells and the plurality of surrounding second wells and in the computer determining a position between each of the plurality of first wells and the plurality of second wells surrounding each of the plurality of first wells of a fluid front of a fluid injected into each of the plurality of first wells.

11. The method of claim 10 further comprising in the computer generating a map of the fluid front with respect to each of the plurality of first wells.

12. The method of claim 11 further comprising at selected times, repeating the inducing a pressure wave in each of the plurality of first wells, repeating detecting the pressure wave in each of the plurality of second wells surrounding each of the plurality of first wells, repeating in the computer determining the K-wave travel times, repeating in the computer determining the position of the fluid front and in the computer generating the map of the fluid front.

13. The method of claim 10 wherein the injected fluid comprises carbon dioxide.

14. The method of claim 10 further comprising repeating inducing the pressure wave and repeating detecting the pressure wave a plurality of times and stacking the detected signals to increase signal to noise ratio in the detected pressure waves.

15. The method of claim 1 further comprising, inducing a pressure wave in a plurality of first wells, detecting a pressure wave in a plurality of second wells in a selected pattern surrounding each of the plurality of the first wells, in the computer determining the guided (K) wave travel time between each of the plurality of first wells and the plurality of surrounding second wells and in the computer determining a position between each of the plurality of first wells and the plurality of second wells surrounding each of the plurality of first wells of a ratio-mix of different fluids between each of the plurality of first wells and the plurality of second wells surrounding each of the plurality of first wells.

16. The method of claim 1 further comprising detecting motion of a ground surface proximate each of the first well and the at least a second well, and in the computer, using the detected ground motion to reduce noise in the detected pressure wave.

17. The method of claim 1 further comprising repeating inducing the pressure wave and repeating detecting the pressure wave a plurality of times and stacking the detected pressure waves to increase signal to noise ratio in the detected pressure waves.

18. The method of claim 1 further comprising synchronizing the inducing a pressure wave and detecting the pressure wave with an absolute time reference.

19. The method of claim 18 wherein the absolute time reference comprises at least one of a global positioning system (GPS) satellite signal and a global navigation satellite system (GNSS) signal.

20. The method of claim 1 further comprising measuring noise using a plurality of sensors comprising at least one of pressure transducers, hydrophones, accelerometers, microphones, and geophones and using the measured noise to reduce surface-based noise and/or to eliminate selected frequency components in the detected pressure wave.

21. The method of claim 1 wherein the pressure wave in the first well comprises a response to natural seismicity acting on the subsurface reservoir.
